(19) United States
(12) Patent Application Publication
(10) Pub. No.: US 2019/0348194 A1
(43) Pub. Date: Nov. 14, 2019

(54) BRAIDED WIRE

(71) Applicants: AutoNetworks Technologies, Ltd., Mie (JP); Sumitomo Wiring Systems, Ltd., Mie (JP); Sumitomo Electric Industries, Ltd., Osaka (JP)

(72) Inventors: Kensuke Yamada, Mie (JP); Yasuyuki Otsuka, Mie (JP); Kinji Taguchi, Mie (JP); Toru Shimizu, Mie (JP); Masaharu Suetani, Mie (JP); Hirotaka Baba, Mie (JP); Takeshi Shimizu, Mie (JP)

(21) Appl. No.: 16/349,653

(22) PCT Filed: Nov. 8, 2017
(86) PCT No.: PCT/JP2017/040234

§ 371 Date: May 14, 2019

(30) Foreign Application Priority Data
Nov. 18, 2016 (JP) 2016-225361
Apr. 27, 2017 (JP) 2017-088541

(51) Int. Cl. H01B 5/12; D04C 1/02; B60R 16/02

(52) U.S. Cl. CPC H01B 5/12; D10B 2505/12; B60R 16/0215; D04C 1/02

(57) ABSTRACT

An aluminum-based braided wire (1) with good abrasion resistance is provided. The braided wire (1) has a plurality of braided strands (2). The braided wire (1) has a tubular shape. The strands (2) each include a strand main body (20) constituted by an aluminum wire or an aluminum alloy wire, and a fretting-corrosion suppression coating (21) covering an outer circumferential surface of the strand main body (20). The fretting-corrosion suppression coating (21) may be constituted by a chemical conversion coating or an alumite coating. If the fretting-corrosion suppression coating (21) is an alumite coating, the braided wire (1) further includes conductive layers (22) respectively covering outer surfaces of the fretting-corrosion suppression coatings (21).

### TECHNICAL FIELD

The present invention relates to a braided wire.

### BACKGROUND

Conventionally, braided wires obtained by braiding a plurality of strands into a tubular shape are used in a wire harness used in a vehicle such as an automobile. As disclosed in Patent Document 1, for example, copper-based strands mainly composed of copper, such as bare soft copper wires, oxygen-free soft copper wires, and tin-plated soft copper wires, have been used as strands constituting this type of braided wire.

In recent years, in order to reduce the weight of a wire harness and the like, studies have been conducted to use aluminum-based strands mainly composed of aluminum, instead of copper-based strands.

### PRIOR ART DOCUMENT

### Patent Document

Patent Document 1: JP 2015-018756A

### SUMMARY OF THE INVENTION

### Problems to be Solved

However, aluminum has a larger frictional coefficient than copper. Thus, a braided wire constituted by aluminum-based strands has poorer abrasion resistance than a braided wire constituted by copper-based strands. Thus, there is a risk with a braided wire constituted by aluminum-based strands that the strands will be eventually disconnected due to the strands undergoing abrasion caused by vibration that is applied when in use while the vehicle is traveling, for example.

The present invention is made in light of the above-described circumstances, and provides an aluminum-based braided wire with good abrasion resistance.

### Means to Solve the Problem

An aspect of the present invention is a tubular braided wire having a plurality of braided strands,

in which the strands each include a strand main body constituted by an aluminum wire or an aluminum alloy wire, and

a fretting-corrosion suppression coating covering an outer circumferential surface of the strand main body.

### Effect of the Invention

In the braided wire, the strands constituting the braided wire each include a strand main body constituted by an aluminum wire or an aluminum alloy wire, and a fretting-corrosion suppression coating covering an outer circumferential surface of the strand main body. Thus, the braided wire is capable of preventing abrasion of the strand main bodies that leads to disconnection of the strands because fretting corrosion of the strand main bodies is suppressed by the fretting-corrosion suppression coatings even if the braided strands rub against each other due to vibration being applied to the braided wire while the vehicle is traveling, for example. Thus, according to the above-described braided wire, it is possible to obtain an aluminum-based braided wire with good abrasion resistance.

### BRIEF DESCRIPTION OF THE DRAWINGS

FIG. 1 is a diagram of an external appearance schematically showing a braided wire according to Working Example 1.

FIG. 2 is a diagram schematically showing a cross section taken along line II-II in FIG. 1.

FIG. 3 is a diagram schematically showing a cross section of each of the strands constituting the braided wire according to Working Example 1.

FIG. 4 is a diagram schematically showing a cross section of each of the strands constituting a braided wire according to Working Example 3.

### DETAILED DESCRIPTION TO EXECUTE THE INVENTION

The braided wire is obtained by braiding a plurality of strands into a tubular shape. In the braided wire, the strands each have a strand main body and a fretting-corrosion suppression coating.

The strand main body is constituted by an aluminum wire or an aluminum alloy wire. Specific examples of the aluminum alloy include 1000 series Al alloys, 3000 series Al alloys, 5000 series Al alloys, 6000 series Al alloys, and 7000 series Al alloys. Note that, in the braided wire, the strand main bodies of the strands may also be made of the same material or different materials.

The aluminum alloy constituting an aluminum alloy wire may have a tensile strength of 200 MPa or more, and an electrical conductivity of 50% IACS or more. According to this configuration, the strength and the conductivity of the strand main body are increased, and thus, it is possible to obtain a braided wire of which resistance to abrasion caused by vibration is easily increased while good shield performance is ensured, together with a fretting-corrosion suppression coating formation effect. From the viewpoint of increasing resistance to abrasion caused by vibration, the tensile strength is preferably 210 MPa or more, and more preferably 220 MPa or more. Also, from the viewpoint of ensuring conductivity, for example, the tensile strength may be 280 MPa or less, preferably 270 MPa or less, and more preferably 260 MPa or less. Also, from the viewpoint of easily ensuring good shield performance and the like, the electrical conductivity may be preferably 52% IACS or more, and more preferably 54% IACS or more. Also, from the viewpoint of increasing resistance to abrasion caused by vibration, for example, the tensile strength may be 58% IACS or less, preferably 57% IACS or less, and more preferably 56% IACS or less. Note that an example of the chemical composition of an aluminum alloy having the above-described tensile strength and the above-described electrical conductivity is a chemical composition containing Mg in an amount of 0.1 mass % or more and 1.5 mass % or less, Si in an amount of 0.03 mass % or more and 2.0 mass % or less, and Cu in an amount of 0.05 mass % or more and 0.5 mass % or less, in which the remaining portion includes Al and inevitable impurities, and a mass ratio between Mg and Si (Mg/Si) is 0.8 or more and 3.5 or less. Note that the above-described chemical composition may further contain at least one element of Fe in an amount of 0.1 mass % or more and 1.0 mass % or less, and Cr in an amount of 0.01 mass % or more and 0.5 mass % or less. Also, the above-described chemical composition may further contain at least one element of 500 ppm or less of Ti and 50 ppm or less of B in a mass proportion.

The outer circumferential surface of the strand main body is covered with a fretting-corrosion suppression coating. Specifically, a configuration is possible in which at least the outer circumferential surfaces of the strand main bodies are covered with a fretting-corrosion suppression coating at sites at which the plurality of braided strands come into contact with each other. From the viewpoint of improving the reliability of abrasion resistance, which ensures an abrasion-resistance improvement effect, for example, the entire outer circumferential surface of the strand main body is preferably covered with the fretting-corrosion suppression coating.

The fretting-corrosion suppression coating is a coating for suppressing fretting corrosion of the strand main bodies caused by the strands rubbing against each other due to vibration of the braided wire. Specifically, the fretting-corrosion suppression coating may be constituted by a chemical conversion coating or an alumite coating (an anodized coating). This configuration ensures the above-described functional effects.

More specifically, if the fretting-corrosion suppression coating is constituted by a chemical conversion coating, the frictional coefficient of the surface of a strand is lower than a bare aluminum-based strand, and the slidability of the strands are easily improved, and thus the above-described fretting corrosion can be easily suppressed. Thus, a braided wire that is advantageous in increasing abrasion resistance can be easily obtained in the above-described case. Also, as a result of an improvement in the slidability of the strands, the linear velocity can be easily increased in a braiding process in the manufacturing of a braided wire. Thus, a braided wire that is advantageous in improving mass productivity can be easily obtained in the above-described case. Also, in the above-described case, the thickness of the fretting-corrosion suppression coating may be made smaller than that of a plating film or the like, and thus it is advantageous in reducing the diameter of each strand and reducing the weight of a braided wire. Also, the conductivity of a chemical conversion coating is easily ensured. Thus, in the above-described case, it is possible to obtain a braided wire whose shield performance is easily ensured.

On the other hand, if the fretting-corrosion suppression coating is constituted by an alumite coating, a hard fretting-corrosion suppression coating is formed on the outer circumferential surface of the strand main body, and thus, the above-described fretting corrosion can be easily suppressed. Also, the alumite coating is more likely to have a sufficient thickness than the chemical conversion coating. Thus, a braided wire that is advantageous in increasing abrasion resistance is easily obtained in the above-described case.

Note that the braided wire may be constituted by strands having a fretting-corrosion suppression coating constituted by a chemical conversion coating, may be constituted by strands having a fretting-corrosion suppression coating constituted by an alumite coating, or may be constituted by both strands.

The chemical conversion coating may be formed by performing chemical conversion treatment on the outer circumferential surface of a strand main body. Specifically, a Cr-containing coating, a Zr-containing coating, a Ti-containing coating, a phosphate-containing coating, and the like may be used as the chemical conversion coating. This configuration ensures the above-described functional effects. Specifically, the Cr-containing coating may be constituted by a chromate coating (also including a chromate phosphate coating), for example. The chromate coating may be formed by subjecting the outer circumferential surface of a strand main body to chromate treatment. Specifically, the Zr-containing coating and the Ti-containing coating may be constituted by a non-chromate coating that contains Zr and/or Ti and does not contain chromium. The non-chromate coating may be formed by subjecting the outer circumferential surface of the strand main body to non-chromate treatment. The phosphate containing-coating may be formed by subjecting the outer circumferential surface of the strand main body to phosphate treatment.

Specifically, the chemical conversion coating has a thickness of 10 nm or more and 150 nm or less. This configuration ensures the above-described functional effects. The chemical conversion coating preferably has a thickness of 25 nm or more and 125 nm or less, and more preferably has a thickness of 50 nm or more and 100 nm or less.

On the other hand, the alumite coating may be formed by performing anodic oxidation treatment on the outer circumferential surface of a strand main body.

Specifically, the alumite coating may have a thickness of 10 μm or more and 150 μm or less. This configuration ensures the above-described functional effects. The alumite coating may have a thickness of 25 μm or more and 125 μm or less, and more preferably have a thickness of 50 μm or more and 100 μm or less.

If the fretting-corrosion suppression coating is an alumite coating, the above-described braided wire may also have conductive layers respectively covering outer surfaces of the fretting-corrosion suppression coatings. The alumite coating has poorer conductivity than a chemical conversion coating such as a chromate coating. Thus, according to the above-described configuration, it is possible to obtain a braided wire whose shield performance is easily ensured by ensuring the conductivity using the conductive layer while fretting corrosion is suppressed by the fretting-corrosion suppression coating constituted by an alumite coating.

A preferred example of the conductive layer may be a metal (including an alloy) layer such as a plating layer. Specific examples of the conductive layer include an Sn plating layer, an Sn alloy plating layer, an Ag plating layer, an Ag alloy plating layer, an Au plating layer, and an Au alloy plating layer. Note that the conductive layer may be constituted by one, or two or more layers.

Specifically, the conductive layer may have a thickness of 1 μm or more and 30 μm or less. This configuration ensures the above-described functional effects. The conductive layer may preferably have a thickness of 5 μm or more and 25 μm or less, and more preferably have a thickness of 10 μm or more and 20 μm or less.

The above-described braided wire may be suitably used in a vibration environment. In this case, the above-described functional effects are sufficiently exerted.

The braided wire may be suitably used in a vehicle. Specifically, the braided wire may be applied to a wire harness for a vehicle, for example. More specifically, the braided wire may be used to cover an outer surface of a wire harness for a vehicle, for example. Also, the braided wire may be used to cover an outer surface of one, or two or more electrical wires constituting a wire harness for a vehicle. Also, the braided wire may be disposed between conductors of electrical wires and insulators constituting a wire harness for a vehicle to cover the conductors. Examples of the vehicle may include automobiles, electric railcars, trains, and motorcycles.

Note that the above-described configurations may be combined as needed in order to obtain the above-described functional effects and the like.

### WORKING EXAMPLES

Hereinafter, braided wires of working examples will be described using the drawings.

### Working Example 1

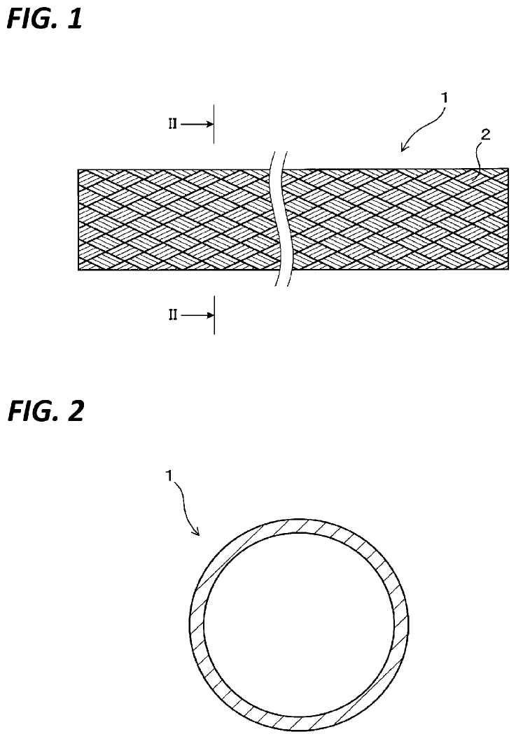

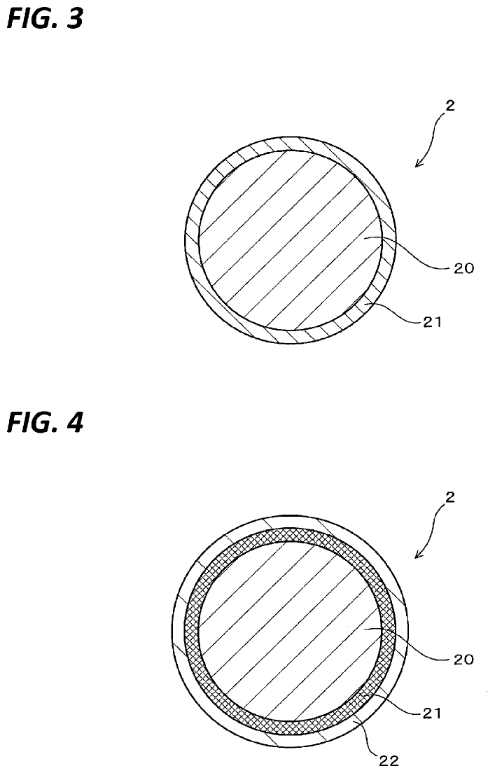

A braided wire of Working Example 1 will be described using FIGS. 1 to 3. As shown in FIGS. 1 to 3, a braided wire 1 of this example has a plurality of braided strands 2. The braided wire 1 has a tubular shape. Note that the strands 2 are omitted in FIG. 2.

The strands 2 each have a strand main body 20 constituted by an aluminum wire or an aluminum alloy wire, and a fretting-corrosion suppression coating 21 covering the outer circumferential surface of the strand main body 20. In this example, specifically, the fretting-corrosion suppression coating 21 is a chemical conversion coating. More specifically, the chemical conversion coating is a chromate coating that is one type of Cr-containing coating.

### Working Example 2

A braided wire of Working Example 2 will be described. Specifically, in a braided wire 1 according to this example, the fretting-corrosion suppression coating 21 is an alumite coating. The other configurations are similar to those of Working Example 1.

### Working Example 3

A braided wire of Working Example 3 will be described using FIG. 4. As shown in FIG. 4, in a braided wire 1 of this example, a strand 2 has a strand main body 20 constituted by an aluminum wire or an aluminum alloy wire, a fretting-corrosion suppression coating 21 covering the outer circumferential surface of the strand main body 20, and a conductive layer 22 covering the outer circumferential surface of the fretting-corrosion suppression coating 21. In this example, specifically, the fretting-corrosion suppression coating 21 is an alumite coating. Also, specifically, the conductive layer is an Sn plating layer or an Sn alloy plating layer. The other configurations are similar to those of Working Example 1.

Hereinafter, braided wire samples were produced and evaluations were made. Experimental Examples therefor will be described.

### EXPERIMENTAL EXAMPLES

### Production of Braided Wires

After the outer circumferential surface of an Al alloy wire constituted by a 1000 series Al alloy having a diameter of 0.26 mm was subjected to degreasing treatment, chromate treatment was performed using a chromate treatment liquid (“PALCOAT 3700”, containing Cr, manufactured by Nihon Parkerizing Co., Ltd.) under treatment conditions at a temperature of 60° C. for 2 minutes, and the resulting Al alloy wire was washed with water. Accordingly, a coated strand (1) having a strand main body constituted by the aluminum alloy wire and a chemical conversion coating (specifically, a chromate coating having a thickness of 50 to 100 nm) covering the outer circumferential surface of the strand main body was prepared.

After the Al alloy wire constituted by the 1000 series Al alloy having a diameter of 0.26 mm was subjected to desmutting, anodic oxidation treatment was performed under treatment conditions at a temperature of 20 to 25° C. for 30 minutes. Accordingly, a coated strand (2) having a strand main body constituted by the aluminum alloy wire and an alumite coating (having a thickness of 30 μm) covering the outer circumferential surface of the strand main body was prepared.

After Zn was attached to the surface of the coated strand (2) as an underlayer, Sn plating was performed thereon using an electroplating method (voltage was 0.3 V, current was 0.13 A). Accordingly, a coated strand having a conductive layer (3) that further has a conductive layer (having a thickness of 2 μm) constituted by an Sn plating layer covering the outer circumferential surface of an alumite coating was prepared.

An Al alloy wire having a diameter of 0.26 mm was prepared, the Al alloy wire being made of an improved Al alloy satisfying the above-described chemical composition, having a tensile strength of 200 MPa or more and having an electrical conductivity of 50% IACS or more. After the outer circumferential surface of this Al alloy wire was subjected to degreasing treatment, chromate treatment was performed using a chromate treatment liquid (“PALCOAT 3700”, containing Cr, manufactured by Nihon Parkerizing Co., Ltd.) under treatment conditions at a temperature of 60° C. for 2 minutes, and the resulting Al alloy wire was washed with water. Accordingly, a coated strand (4) having a strand main body constituted by an aluminum alloy wire and a chemical conversion coating (specifically, a chromate coating having a thickness of 50 to 100 nm) covering the outer circumferential surface of the strand main body was prepared.

A plurality of the coated strands (1) were braided into a tubular shape, and thus a braided wire of Sample 1 was obtained. A plurality of the coated strands (2) were braided into a tubular shape, and thus a braided wire of Sample 2 was obtained. A plurality of the coated strands each having a conductive layer (3) were braided into a tubular shape, and thus a braided wire of Sample 3 was obtained. A plurality of the coated strands (4) were braided into a tubular shape, and thus a braided wire of Sample 4 was obtained.

A plurality of Cu strands having a diameter of 0.26 mm were braided into a tubular shape, and thus a braided wire of Sample 1C was obtained. A plurality of Al alloy wires made of a 1000 series Al alloy and having a diameter of 0.26 mm were braided into a tubular shape, and thus a braided wire of Sample 2C was obtained. A plurality of Al alloy wires made of a 6000 series Al alloy and having a diameter of 0.26 mm were braided into a tubular shape, and thus a braided wire of Sample 3C was obtained. A plurality of the Al alloy wires made of the improved Al alloy and having a diameter of 0.26 mm were braided into a tubular shape, and thus a braided wire of Sample 4C was obtained. Note that the number of strands was set to 44 and the number of ends was set to 4 for a braiding configuration of each of the produced braided wires. Also, in this experimental example, the length of each of the braided wires in the longitudinal direction was set to 1 m.

### Coefficient of Kinetic Friction

With regard to each of the braided wires, the coefficient of kinetic friction of strands constituting each of the braided wires was measured as follows. That is, one strand was fixed straight on a flat iron plate. Next, a 100 g weight was placed on this strand, the weight was swept in an axial direction of the strand at a sweep speed of 50 mm/min, and the frictional force generated at that time was measured. Next, the coefficient of kinetic friction was calculated using a calculation equation F=μN (where F indicates a frictional force, μ indicates a coefficient of kinetic friction, and N indicates a normal force).

### Vibration Test

A disconnection rate was checked by vibrating a braided wire one million times under a constant strain (specifically, 0.005 strain). Note that the disconnection rate was obtained using a calculation equation 100×(the number of disconnected strands)/(the total number of strands). The case where the disconnection rate was 10% or less was evaluated as “A+” due to the braided wire having excellent abrasion resistance. The case where the disconnection rate exceeded 10% and was 15% or less was evaluated as “A” due to the braided wire having good abrasion resistance. The case where the disconnection rate exceeded 15% and was 20% or less was evaluated as “B” due to the braided wire having abrasion resistance to some extent. The case where the disconnection rate exceeded 20% was evaluated as “C” due to the braided wire having poor abrasion resistance. Note that this vibration test was performed on the produced braided wires.

### Shield Performance

A sample was prepared by inserting three insulated electric wires having a length of 1000 mm into a tube of a braided wire. Then, the shield performance of the sample was measured using an absorption clamp method. The measurement apparatus used in the absorption clamp method had a spectrum analyzer, a tracking generator, a pair of shield boxes, an absorption clamp, and a terminator. The shield boxes were each grounded. The absorption clamp was disposed between the pair of shield boxes. A terminator was provided in one of the shield boxes of the pair, and was grounded via the one of the shield boxes. The spectrum analyzer was connected to the absorption clamp, and was configured to measure a signal received by the absorption clamp. Note that “KT-10” manufactured by Kyohritsu Electronic Industry Co., Ltd. was used as the absorption clamp. Also, “E4402B” manufactured by Agilent was used as the spectrum analyzer.

The sample was attached using the procedure below. First, the sample was inserted into the absorption clamp, and both ends were fixed to the inside of a shield box. Then, both ends of the braided wire were connected to the shield boxes respectively, and the braided wire was grounded via the shield boxes. Then, an electrical wire conductor of the sample inserted into the one shield box was connected to the terminator, and was grounded via the terminator. Thereafter, the electrical wire conductor of the sample inserted in the other shield box was connected to the tracking generator.

After the sample was attached to the measurement apparatus, a high-frequency signal of 10 MHz generated from the tracking generator was input to the electrical wire conductor. Then, a high-frequency signal that leaked out of the sample was received by the absorption clamp, and the magnitude of the high-frequency signal was measured using the spectrum analyzer. Thereafter, a ratio of the magnitude of the leaked high-frequency signal with respect to the magnitude of the input high-frequency signal was calculated, and this ratio was regarded as an amount of induced noise (dB). The case where the amount of induced noise was 40 dB or more was evaluated as ^{C.} The case where the amount of induced noise exceeded 31 dB and was 39 dB or less was evaluated as “B”. The case where the amount of induced noise exceeded 25 dB and was 30 dB or less was evaluated as “A−”. The case where the amount of induced noise exceeded 20 dB and was 25 dB or less was evaluated as “A.” The case where the amount of induced noise was 20 dB or less was evaluated as “A+”.

### Slidability

On each of the braided wires, a braiding process test (300 m braiding) was performed at a linear velocity (linear velocity) that is the same as that of mass production of braided wires constituted by Cu strands. In the braiding process test, the case where no kink or disconnection occurred was evaluated as “A” due to the braided wire having excellent slidability. The case where no kink or disconnection occurred but partial irregular braiding occurred was evaluated as “B” due to the braided wire having good slidability. The case where a kink and/or disconnection occurred was evaluated as “C” due to the braided wire having poor slidability.

The above-described evaluation results are collectively shown in Table 1.

TABLE 1

| | Samples | | | | | | | |
|---|---|---|---|---|---|---|---|---|
| | 1 | 2 | 3 | 4 | 1C | 2C | 3C | 4C |
| Materials of | 1000 series | 1000 series | 1000 series | Improved Al | Cu | 1000 series | 6000 series | Improved Al |
| Wires | Al alloy | Al alloy | Al alloy | alloy | | Al alloy | Al alloy | alloy |
| Type of | Chemical | Alumite | Alumite | Chemical | No coating | No coating | No coating | No coating |
| Coatings | conversion | coating | coating | conversion | | | | |
| | coating | | | coating | | | | |
| Presence of | No | No | Yes | No | No | No | No | No |
| Conductive | | | | | | | | |
| Layer | | | | | | | | |
| Coefficient | 0.167~0.170 | 0.170~0.174 | 0.170~0.174 | 0.167~0.170 | 0.166~0.170 | 0.176~0.180 | 0.175~0.180 | 0.175~0.180 |
| of Kinetic | | | | | | | | |
| Friction | | | | | | | | |
| Results of | A | A | A | A+ | A | C | B | B |
| Vibration | | | | | | | | |
| Tests | | | | | | | | |
| Shield | A | B | A+ | A− | A | A | C | A− |
| Performance | | | | | | | | |
| Sliding | A | B | B | A | A | C | C | C |
| Properties | | | | | | | | |

According to Table 1, the following can be understood. The braided wire of Sample 1C was a braided wire constituted by copper-based strands. The braided wires of Sample 2C to Sample 4C were braided wires constituted by bare aluminum-based strands. As shown in Table 1, the coefficient of kinetic friction of the bare aluminum-based strands is larger than the coefficient of kinetic friction of the copper-based strand. Thus, the braided wires of Sample 2C to Sample 4C did not suppress fretting corrosion of the strands caused by vibration, compared to the braided wire of Sample 1C, and the strands were disconnected. Thus, it cannot be said that the braided wires of Sample 2C to Sample 4C have good abrasion resistance, compared to the braided wire constituted by the copper-based strands.

In contrast, in each of the braided wires of Sample 1 to Sample 4, the fretting-corrosion suppression coating (specifically, the chemical conversion coating in Sample 1 and Sample 4, and the alumite coating in Sample 2 and Sample 3) covered the outer circumferential surface of the strand main body constituted by the aluminum alloy wire. Thus, in the braided wires of Sample 1 to Sample 4, even if the strands rubbed against each other due to vibration, fretting corrosion of the strand main body was suppressed by the fretting-corrosion suppression coating, and abrasion of the strand main body that would lead to disconnection of the strands was prevented. Thus, it was confirmed that, according to the braided wires of Sample 1 to Sample 4, aluminum-based braided wires having good abrasion resistance were obtained.

A further consideration will be discussed. The strands in the braided wires of Sample 1 and Sample 4 each have a chemical conversion coating and thus have a coefficient of kinetic friction to a similar extent to that of the copper-based strand in Sample 1C. Thus, the braided wires of Sample 1 and Sample 4 suppressed the above-described fretting corrosion.

Also, in the braided wires of Sample 2 and Sample 3, the strands had an alumite coating having a sufficient thickness, compared to the chemical conversion coating. Thus, the braided wires of Sample 2 and Sample 3 suppressed the above-described fretting corrosion. However, as can be understood from the evaluation results of the shield performance in the braided wire of Sample 2, the alumite coating has poor conductivity. Thus, it was confirmed that, like the braided wire of Sample 3, as a result of the outer surface of the alumite coating being coated with the conductive layer, it is possible to obtain a braided wire whose shield performance is easily ensured by ensuring the conductivity using the conductive layer while fretting corrosion is suppressed by the alumite coating.

Also, as shown in the results of the braided wires of Sample 1C to Sample 4C, in the case where the 1000 series Al alloy (Sample 2C), the 6000 series Al alloy (Sample 3C), and the improved Al alloy (Sample 4C) improved based on a 6000 series Al alloy were used, the coefficient of kinetic friction was large at 0.175 or more, and the strands had poor slidability, compared to the case where copper (Sample 1C) was used. Thus, in the case where the braided wire was constituted using the 1000 series Al alloy, the 6000 series Al alloy, and the improved Al alloy as is, when the braiding process was performed at a linear velocity that was the same as that for the copper-based braided wire, a kink and disconnection were likely to occur, and it was difficult to increase the linear velocity. In contrast, as shown in the results of the braided wires of Samples 1 to 4, even in the case where the 1000 series Al alloys (Samples 1 to 3) and the improved Al alloy (Sample 4) were used, as a result of forming the fretting-corrosion suppression coating, the coefficient of kinetic friction was 0.170 or less (when chemical conversion coating was formed) and 0.174 or less (when the alumite coating was formed), and the slidability increased, and thus even if the braiding process was performed at a linear velocity that is the same as that for the copper-based braided wire, a kink and disconnection were easily suppressed. It was confirmed that, according to this result, even with the aluminum-based braided wire, as a result of forming the fretting-corrosion suppression coating, the slidability of the strands were improved due to the coefficient of kinetic friction of the surfaces of the strands decreasing, and the mass production speed equivalent to that for the copper-based braided wire was ensured in the braiding process for braiding the braided wire, and it is advantageous in improving the mass productivity. Note that, if an anticorrosive is further applied to the surface of the fretting-corrosion suppression coating, it is expected that the above-described effects can be made more reliable.

Also, it can be understood that, as shown in the results of the braided wire of Sample 2C, the 1000 series Al alloy has high electrical conductivity and is advantageous in obtaining good shield performance, but has a high coefficient of kinetic friction and low strength, and thus the 1000 series Al alloy is disadvantageous in ensuring resistance to abrasion caused by vibration. On the other hand, it can be understood that, as shown in the results of the braided wire of Sample 3C, the 6000 series Al alloy has higher strength than the 1000 series Al alloy, and is advantageous in ensuing resistance to abrasion caused by vibration, but has low electrical conductivity, and thus is disadvantageous in obtaining good shield performance. Note that the 3000 series Al alloy and the 5000 series Al alloys have the same tendency as that of the 6000 series Al alloys. In contrast, it was confirmed that, according to the braided wire of Sample 4, as a result of using, in the strand main body, the Al alloy having a tensile strength of 200 MPa or more and an electrical conductivity of 50% IACS or more, the resistance to abrasion caused by vibration is easily increased while good shield performance is ensured.

Although working examples and experimental examples of the present invention have been described in detail above, the present invention is not limited to the above-described working examples and experimental examples, and various modifications can be made without departing from the gist of the present invention.

1. A tubular braided wire having a plurality of braided strands,
wherein the strands each include a strand main body constituted by an aluminum wire or an aluminum alloy wire, and
a fretting-corrosion suppression coating covering an outer circumferential surface of the strand main body.

2. The braided wire according to claim 1,
wherein the fretting-corrosion suppression coating is a chemical conversion coating or an alumite coating.

3. The braided wire according to claim 2,
wherein the chemical conversion coating is a Cr-containing coating, a Zr-containing coating, or a Ti-containing coating.

4. The braided wire according to claim 2,
wherein the fretting-corrosion suppression coating is the alumite coating, and
the braided wire further comprises conductive layers respectively covering outer surfaces of the fretting-corrosion suppression coatings.

5. The braided wire according to claim 2,
wherein the chemical conversion coating has a thickness of 10 nm or more and 150 nm or less.

6. The braided wire according to claim 2,
wherein the alumite coating has a thickness of 10 μm or more and 150 μm or less.

7. The braided wire according to claim 1,
wherein an aluminum alloy constituting the aluminum alloy wire has a tensile strength of 200 MPa or more, and has an electrical conductivity of 50% IACS or more.

8. The braided wire according to claim 1, which is to be used in a vehicle.
